(19) United States
(12) Patent Application Publication
(10) Pub. No.: US 2026/0264649 A1
(43) Pub. Date: Sep. 10, 2026

(54) DRIVING ASSISTANCE SYSTEM, STORAGE MEDIUM STORING DRIVING ASSISTANCE PROGRAM, AND DRIVING ASSISTANCE METHOD

(71) Applicant: J-QuAD DYNAMICS Inc., Tokyo (JP)

(72) Inventors: Masaki SHIOTA, Tokyo (JP); Manabu NAGASAKA, Tokyo (JP); Toyohito NOZAWA, Tokyo (JP); Takuto KOZAKI, Tokyo (JP)

(21) Appl. No.: 19/660,756

(22) Filed: Apr. 28, 2026

Related U.S. Application Data
(63) Continuation of application No. PCT/JP2024/033144, filed on Sep. 17, 2024.

(30) Foreign Application Priority Data
Nov. 7, 2023 (JP) 2023-190328

(51) Int. Cl. B60T 8/1755; B60W 10/184; B60W 10/20; B60W 30/09

(52) U.S. Cl. CPC B60T 8/17558; B60W 10/184; B60W 10/20; B60W 30/09; B60T 2201/022; B60W 2520/14

(57) ABSTRACT

A driving assistance system assists collision avoidance with an object during driving of a host vehicle. The driving assistance system includes a processor configured to execute: performing phase advance adjustment of a phase of a required yaw rate required for the host vehicle so as to be advanced relative to a phase that follows a driving trajectory planned for the host vehicle toward collision avoidance; and controlling, in the host vehicle, a left-right distribution of braking force applied from a braking actuator to wheels to a braking distribution correlated with the required yaw rate subjected to the phase advance adjustment.

### CROSS REFERENCE TO RELATED APPLICATION

The present application is a continuation application of International Patent Application No. PCT/JP2024/033144 filed on September 17, 2024 which designated the U. S. and claims the benefit of priority from Japanese Patent Application No. 2023-190328 filed on November 7, 2023. The entire disclosures of all of the above applications are incorporated herein by reference.

### TECHNICAL FIELD

The present disclosure relates to a driving assistance technology that supports collision avoidance with an object in driving of a vehicle.

### BACKGROUND

A technology disclosed in a related art controls a steering torque output to an actuator in order to avoid a collision with an object in a vehicle.

According to an aspect of the present disclosure, a driving assistance system for assisting collision avoidance with an object during driving of a host vehicle includes a processor. The processor may be configured to execute: performing phase advance adjustment of a phase of a required yaw rate required for the host vehicle so as to be advanced relative to a phase that follows a driving trajectory planned for the host vehicle toward collision avoidance; and controlling, in the host vehicle, a left-right distribution of braking force applied from a braking actuator to wheels to a braking distribution correlated with the required yaw rate subjected to the phase advance adjustment.

### BRIEF DESCRIPTION OF DRAWINGS

FIG. 1 is a block diagram showing a physical configuration of a driving assistance system according to a first embodiment.

FIG. 2 is a schematic diagram showing a driving environment of a host vehicle to which the first embodiment is applied.

FIG. 3 is a block diagram showing a functional configuration of the driving assistance system according to the first embodiment.

FIG. 4 is a flowchart showing a driving assistance flow according to the first embodiment.

FIG. 5 is a flowchart showing a driving control subroutine according to the first embodiment.

FIG. 6 is a graph for explaining the driving assistance flow according to the first embodiment.

FIG. 7 is a flowchart showing a driving assistance flow according to a second embodiment.

FIG. 8 is a flowchart showing a driving control subroutine according to the second embodiment.

FIG. 9 is a graph for explaining the driving assistance flow according to the second embodiment.

FIG. 10 is a graph for explaining the driving assistance flow according to the second embodiment.

### DETAILED DESCRIPTION

In the technology disclosed in a related art, even during deceleration of the vehicle by braking, a target steering angle is merely set in accordance with a lateral movement amount on a driving trajectory required for the predicted collision avoidance. As a result, even if the steering torque for providing the target steering angle matching the lateral movement amount is controlled to be high by a correction gain, it is difficult to cancel a response delay of the steering angle in the actuator itself. Therefore, there has been a concern that accurate tracing of the vehicle with respect to the driving trajectory for collision avoidance may be hindered.

The present disclosure provides a driving assistance system effective for collision avoidance with an object in a vehicle. The present disclosure provides a driving assistance program effective for collision avoidance with an object in a vehicle. The present disclosure provides a driving assistance method effective for collision avoidance with an object in a vehicle.

Hereinafter, technical means of the present disclosure for solving the problem will be described.

According to one aspect of the present disclosure, a driving assistance system for assisting collision avoidance with an object during driving of a host vehicle includes a processor configured to execute: performing phase advance adjustment of a phase of a required yaw rate required for the host vehicle so as to be advanced relative to a phase that follows a driving trajectory planned for the host vehicle toward collision avoidance; and controlling, in the host vehicle, a left-right distribution of braking force applied from a braking actuator to a wheel to a braking distribution correlated with the required yaw rate subjected to the phase advance adjustment.

According to one aspect of the present disclosure, a non-transitory computer readable storage medium stores a driving assistance program for assisting collision avoidance with an object in driving of a host vehicle. The driving assistance program includes instructions for causing a processor to execute the assistance. The instructions causes the processor to execute: performing phase advance adjustment of a phase of a required yaw rate required for the host vehicle so as to be advanced relative to a phase that follows a driving trajectory planned for the host vehicle toward collision avoidance; and controlling, in the host vehicle, a left-right distribution of a braking force applied from a braking actuator to a wheel to a braking distribution correlated with the required yaw rate subjected to the phase advance adjustment.

According to one aspect of the present disclosure, a driving assistance method is executed by a processor for assisting collision avoidance with an object in driving of a host vehicle. The driving assistance method includes: performing phase advance adjustment of a phase of a required yaw rate required for the host vehicle so as to be advanced relative to a phase that follows a driving trajectory planned for the host vehicle toward collision avoidance; and controlling, in the host vehicle, a left-right distribution of a braking force applied from a braking actuator to a wheel to a braking distribution correlated with the required yaw rate subjected to the phase advance adjustment.

According to these aspects, the phase of the required yaw rate required for the host vehicle is adjusted to be advanced relative to the phase following the driving trajectory planned for the host vehicle toward the collision avoidance. Thus, the left-right distribution of the braking force applied from the braking actuator to the wheels in the host vehicle is controlled to the braking distribution correlated with the phase-advance-adjusted required yaw rate. According to this, even if a response delay of the braking force occurs in the braking actuator, the response delay itself can be canceled by starting the control of the braking distribution following the advanced phase of the required yaw rate. Therefore, the braking force following the driving trajectory can be distributed to the left and right wheels in a timely manner to cause the host vehicle to accurately trace the driving trajectory, thereby making it possible to realize driving assistance effective for collision avoidance with the object in the host vehicle.

According to one aspect of the present disclosure, a driving assistance system for assisting collision avoidance with an object during driving of a host vehicle includes a processor configured to execute: performing phase advance adjustment of a phase of a required yaw rate required for the host vehicle so as to be advanced relative to a phase that follows a driving trajectory planned for the host vehicle toward collision avoidance; and controlling, in the host vehicle, a front-rear distribution of a steering angle applied from a steering actuator to a wheel to a steering distribution correlated with the required yaw rate subjected to the phase advance adjustment.

According to one aspect of the present disclosure, a non-transitory computer readable storage medium stores a driving assistance program for assisting collision avoidance with an object in driving of a host vehicle. The driving assistance program includes instructions for causing a processor to execute the assistance. The instructions causes the processor to execute: performing phase advance adjustment of a phase of a required yaw rate required for the host vehicle so as to be advanced relative to a phase that follows a driving trajectory planned for the host vehicle toward collision avoidance; and controlling, in the host vehicle, a front-rear distribution of a steering angle applied from a steering actuator to a wheel to a steering distribution correlated with the required yaw rate subjected to the phase advance adjustment.

According to one aspect of the present disclosure, a driving assistance method is executed by a processor for assisting collision avoidance with an object in driving of a host vehicle. The driving assistance method includes: performing phase advance adjustment of a phase of a required yaw rate required for the host vehicle so as to be advanced relative to a phase that follows a driving trajectory planned for the host vehicle toward collision avoidance; and controlling, in the host vehicle, a front-rear distribution of a steering angle applied from a steering actuator to a wheel to a steering distribution correlated with the required yaw rate subjected to the phase advance adjustment.

According to these aspects, the phase of the required yaw rate required for the host vehicle is adjusted to be advanced relative to the phase following the driving trajectory planned for the host vehicle toward the collision avoidance. Thus, the front-rear distribution of the steering angle applied from the steering actuator to the wheels in the host vehicle is controlled to the steering distribution correlated with the phase-advance-adjusted required yaw rate. According to this, even if a response delay of the steering angle occurs in the steering actuator, the response delay itself can be canceled by starting the control of the steering distribution following the advanced phase of the required yaw rate. Therefore, the steering angle following the driving trajectory can be distributed to the front and rear wheels in a timely manner to cause the host vehicle to accurately trace the driving trajectory, thereby making it possible to realize driving assistance effective for collision avoidance with the object in the host vehicle.

Hereinafter, multiple embodiments of the present disclosure will be described based on the drawings. In each embodiment, components corresponding to each other are denoted by the same reference numerals, and redundant description may be omitted. When only a part of a configuration is described in each embodiment, the configuration of other embodiments described previously can be applied to other parts of the configuration. Furthermore, not only the combinations of configurations explicitly stated in the description of each embodiment, but also configurations of multiple embodiments can be partially combined with each other even if not explicitly stated, provided that there is no particular hindrance to the combination.

### (First Embodiment)

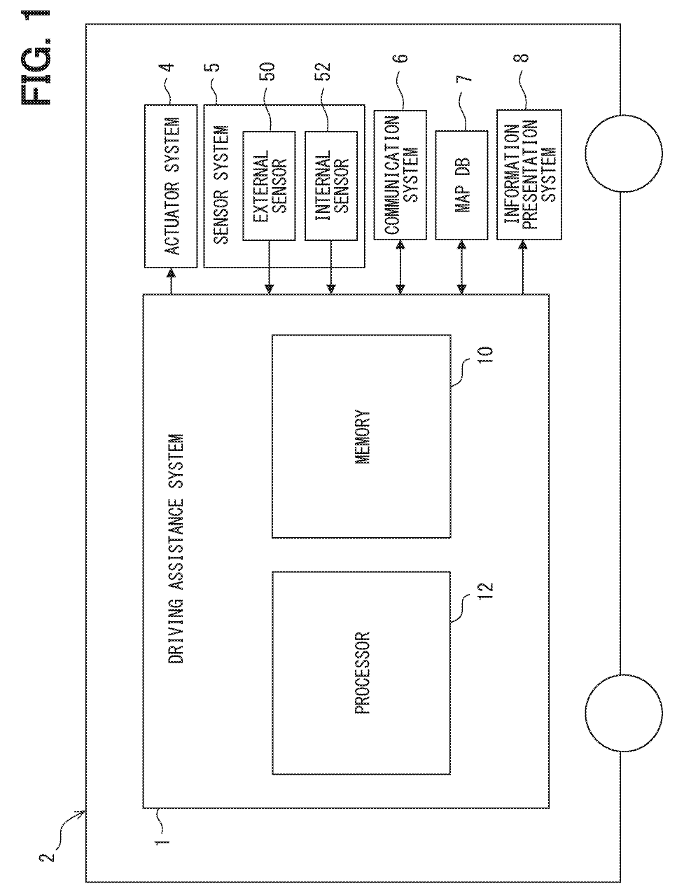

A driving assistance system 1 of a first embodiment shown in FIG. 1 supports driving of a host vehicle 2. At least a part of the driving assistance system 1 is mounted on the host vehicle 2. The host vehicle 2 to which the driving assistance system 1 is applied is preferably capable of realizing, among automated driving levels defined in SAE J3016 or the like, a level in which a manual driving assistance task supporting a manual driving operation of an operator exists together with an automated driving task. Such a host vehicle 2 is a road user such as an automobile or a truck, and may be referred to as an ego-vehicle. As described above, the driving assistance system 1 targets a driver who is on board the host vehicle 2 and capable of performing manual driving operations as an operator of the host vehicle 2 for driving assistance.

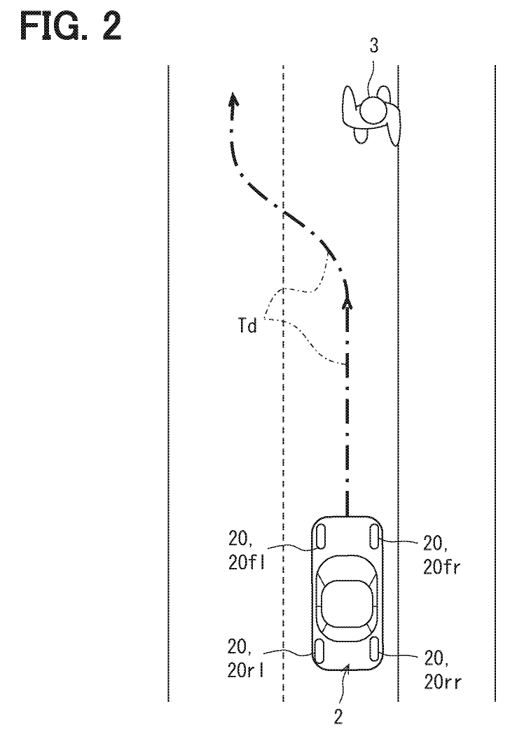

As shown in FIG. 2, in a driving environment where the host vehicle 2 travels, at least one type of object 3 other than the host vehicle 2 exists, such as other road users, obstacles, and structures. Other road users include non-vulnerable road users and vulnerable road users. Non-vulnerable road users are at least one type of mobile body with a human on board, such as automobiles, trucks, motorcycles, and bicycles. Vulnerable users are, for example, pedestrians. Obstacles include at least one type of, for example, construction signs, work signs, and fallen objects. Structures include at least one type of, for example, buildings, road structures, traffic lights, and road signs.

As shown in FIG. 1, an actuator system 4, a sensor system 5, a communication system 6, a map database (DB) 7, and an information presentation system 8 are mounted on the host vehicle 2 together with at least a part of the driving assistance system 1. However, FIG. 1 representatively shows an example in which the entire driving assistance system 1 implemented in the form of a processing circuit (e.g., a processing ECU) or a semiconductor device (e.g., a semiconductor chip) is mounted on the host vehicle 2.

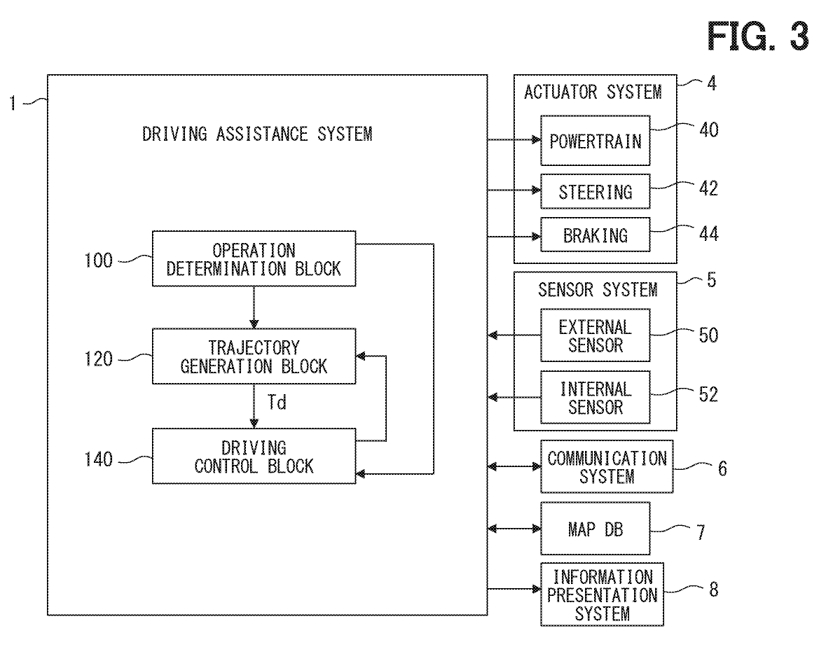

The actuator system 4 is configured to be capable of controlling driving behavior of the host vehicle 2 based on a control command from the driving assistance system 1. As shown in FIG. 3, the actuator system 4 includes at least one type of powertrain actuator 40 among, for example, an internal combustion engine and a motor generator. The actuator system 4 includes at least one type of steering actuator 42, such as a power steering unit. The actuator system 4 includes at least one type of braking actuator 44, such as a brake unit.

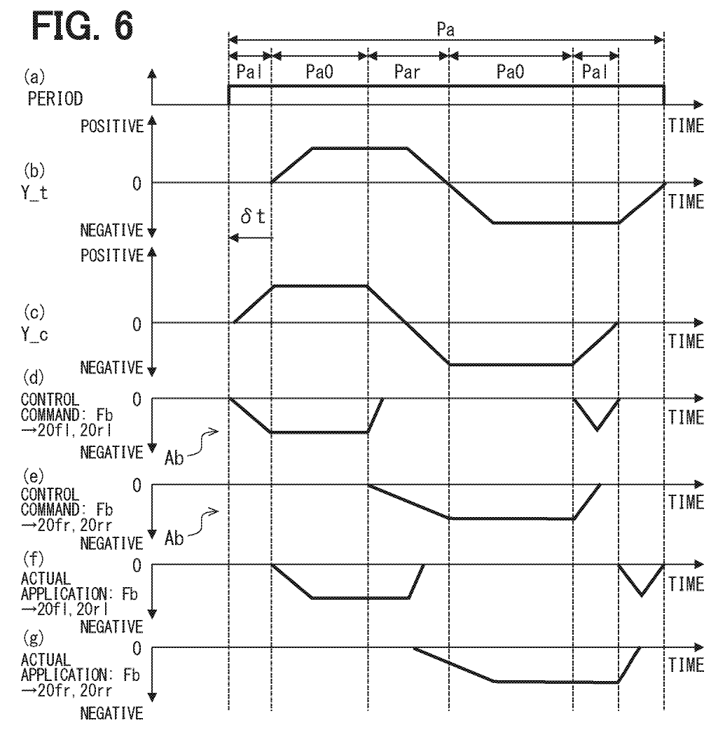

Here, as shown in FIG. 2, front wheels 20fl, 20fr and rear wheels 20rl, 20rr are provided as multiple wheels 20 of the host vehicle 2. Thus, the braking actuator 44 independently adjusts respective braking forces Fb individually for the front wheels 20fl, 20fr and respective braking forces Fb individually for the rear wheels 20rl, 20rr as braking forces applied to the host vehicle 2 (see FIG. 6 described later). Accordingly, in the host vehicle 2, left-right distribution and front-rear distribution of the braking force Fb are controllable.

On the other hand, the steering actuator 42 adjusts at least one of a steering angle common to the front wheels 20fl, 20fr and a steering angle common to the rear wheels 20rl, 20rr as a steering angle applied to the host vehicle 2. Accordingly, particularly in the first embodiment, in the host vehicle 2 where the common steering angle of the front wheels 20fl, 20fr and the common steering angle of the rear wheels 20rl, 20rr are adjusted independently of each other, front-rear distribution between these common steering angles is controllable.

As shown in FIG. 1, the sensor system 5 acquires sensing information usable in the driving assistance system 1 by sensing an external environment and an internal environment of the host vehicle 2. For this purpose, the sensor system 5 includes an external sensor 50 and an internal sensor 52.

The external sensor 50 senses the object 3 present in the external environment around the host vehicle 2. The object-sensing type external sensor 50 is at least one type of, for example, an image sensor (i.e., an in-vehicle camera), LiDAR (light detection and ranging / laser imaging detection and ranging), a laser sensor, a millimeter-wave sensor, and a sonar sensor. It is preferable that multiple types of object-sensing type external sensors 50 be implemented in combination so as to be capable of sensing in the forward, lateral, and rearward directions of the host vehicle 2.

The internal sensor 52 senses specific motion-related physical quantities related to vehicle motion inside the host vehicle 2. The motion-sensing type internal sensor 52 is at least one type of, for example, a speed sensor, an acceleration sensor, and a gyro sensor. The internal sensor 52 may sense an operation or state of an occupant including the driver as an occupant on board the host vehicle 2 (i.e., in the vehicle cabin). The occupant-sensing type internal sensor 52 is at least one type of, for example, an accelerator pedal sensor, a steering angle sensor, a steering torque sensor, a brake pedal sensor, a shift sensor, an occupant camera, a steering switch, a biosensor, a seating sensor, and an in-vehicle device switch.

The communication system 6 acquires communication information usable in the driving assistance system 1 by wireless communication. The communication system 6 may receive positioning signals from artificial satellites of a GNSS (global navigation satellite system) existing in the outside of the host vehicle 2. The positioning type communication system 6 is, for example, a GNSS receiver. The communication system 6 may transmit and receive communication signals to and from a V2X system existing in the outside of the host vehicle 2. The V2X communication type communication system 6 is at least one type of, for example, a DSRC (dedicated short range communications) communication device and a cellular V2X (C-V2X) communication device. The communication system 6 may transmit and receive communication signals to and from a mobile terminal in the vehicle cabin of the host vehicle 2. The terminal communication type communication system 6 is at least one type of, for example, a Bluetooth (registered trademark) device, a Wi-Fi (registered trademark) device, and an infrared communication device.

The map DB 7 stores map information usable in the driving assistance system 1. The map DB 7 is configured including at least one type of non-transitory tangible storage medium among, for example, a semiconductor memory, a magnetic medium, and an optical medium. The map DB 7 may be a DB of a locator that estimates a self-position of the host vehicle 2. The map DB 7 may be a DB of a navigation unit that navigates a driving route of the host vehicle 2. The map DB 7 may be constructed by a combination of multiple types of DBs.

The map DB 7 acquires and stores the latest map information by, for example, V2X communication with an external center via the communication system 6. The map information is converted into data in 2D or 3D as information representing the external environment in which the host vehicle 2 travels. As the three-dimensional map information, digital data of a high-definition map may be adopted. The map information includes road information representing at least one type among, for example, positions, shapes, and road surface conditions of road structures. The map information may include structure information representing at least one type among, for example, positions and shapes of buildings and traffic lights facing the road. The map information may include marking information representing at least one type among, for example, positions and shapes of signs and lane markings attached to the road.

The information presentation system 8 presents notification information to occupants including the driver of the host vehicle 2. The information presentation system 8 presents the notification information by stimulating the vision of the occupant in the host vehicle 2. The visual information presentation type information presentation system 8 is at least one type of, for example, an in-vehicle monitor, a HUD (head-up display), a combination meter, a navigation unit, and an illumination unit. The information presentation system 8 may present the notification information by stimulating the hearing of the occupant. The auditory information presentation type information presentation system 8 is at least one type of, for example, a speaker, a buzzer, and a vibration unit. The information presentation system 8 may present the notification information by stimulating the tactile sensation of the occupant. The tactile sensation information presentation type information presentation system 8 is at least one type of, for example, a vibration unit, a force-feedback unit, and an air conditioning unit.

The driving assistance system 1 is connected to the actuator system 4, the sensor system 5, the communication system 6, the map DB 7, and the information presentation system 8 via at least one type of, for example, a LAN (local area network), a wire harness, an internal bus, and a wireless communication line. The driving assistance system 1 is configured including at least one dedicated computer.

The dedicated computer constituting the driving assistance system 1 may be an integrated ECU (electronic control unit) that integrates driving control of the host vehicle 2. The dedicated computer constituting the driving assistance system 1 may be a sensing ECU that processes sensing information in the driving control of the host vehicle 2. The dedicated computer constituting the driving assistance system 1 may be a recognition ECU that recognizes the external environment in the driving control of the host vehicle 2. The dedicated computer constituting the driving assistance system 1 may be a locator ECU that estimates the self-position of the host vehicle 2.

The dedicated computer constituting the driving assistance system 1 may be a planning ECU that plans driving control of the host vehicle 2. The dedicated computer constituting the driving assistance system 1 may be a navigation ECU that navigates a driving route in the driving control of the host vehicle 2. The dedicated computer constituting the driving assistance system 1 may be an actuator ECU that controls the actuator system 4 as driving control of the host vehicle 2.

The dedicated computer constituting the driving assistance system 1 may be an information management ECU that controls the information presentation system 8 as driving control of the host vehicle 2. The dedicated computer constituting the driving assistance system 1 may be at least one external computer constituting an external center or a mobile terminal, etc., that is communicable via, for example, the communication system 6.

The dedicated computer constituting the driving assistance system 1 has at least one memory 10 and at least one processor 12. The memory 10 is at least one type of non-transitory tangible storage medium among, for example, a semiconductor memory, a magnetic medium, and an optical medium, which stores, in a non-transitory manner, programs and data readable by the computer. The processor 12 includes at least one type of, for example, a CPU (central processing unit), a GPU (graphics processing unit), and a RISC (reduced instruction set computer)-CPU as a core.

The processor 12 executes multiple instructions included in a driving assistance program stored in the memory 10 as software. As a result, the driving assistance system 1 constructs multiple functional blocks for performing driving assistance processing of the host vehicle 2. The multiple functional blocks thus constructed by the driving assistance system 1 include an operation determination block 100, a trajectory generation block 120, and a driving control block 140 shown in FIG. 3.

The operation determination block 100 acquires sensing information from the sensor system 5. The operation determination block 100 generates operation data by determining a manual driving operation of the driver for the host vehicle 2 based on the acquired sensing information. The operation data relating to the manual driving operation may represent at least one type of operation parameter according to the driver's operation among, for example, an accelerator pedal operation amount, a steering operation angle, a steering operation torque, a brake pedal operation amount, and a shift operation position.

The trajectory generation block 120 acquires sensing information from the sensor system 5. The trajectory generation block 120 acquires communication information from the communication system 6. The trajectory generation block 120 acquires map information from the map DB 7. The trajectory generation block 120 acquires data of past control commands to the host vehicle 2 from the driving control block 140. The trajectory generation block 120 generates recognition data recognizing the external environment and internal environment of the host vehicle 2 by individually processing and then fusing these acquired information and data. The recognition data generated by the trajectory generation block 120 in this way represents the states of the external environment and internal environment recognized for each driving scene in which the host vehicle 2 travels.

Specifically, the trajectory generation block 120 preferably generates the recognition data by localization for recognizing a self-state of the host vehicle 2. The recognition data relating to the self-state may represent at least one motion-related physical quantity among, for example, position, speed, acceleration, jerk, yaw rate, and yaw angle that were realized (manifested) in the host vehicle 2 in accordance with a control command in the driving control block 140 described later. The trajectory generation block 120 preferably generates the recognition data by recognizing the object 3 in external environment around the host vehicle 2. The recognition data relating to the object 3 may represent at least one type of kinetic physical quantity among, for example, a separation distance, a movement direction, a relative speed, a relative acceleration, and a time to collision (TTC) with the host vehicle 2.

Based on the generated recognition data, the trajectory generation block 120 plans a driving trajectory Td (see FIG. 2) targeted in future driving of the host vehicle 2. The driving trajectory Td defines a time-series change for each control cycle assumed in the future ahead of the present time regarding a motion parameter targeted as the self-state of the host vehicle 2. Specifically, the driving trajectory Td preferably represents position coordinates for each control cycle of a locus that the host vehicle 2 is to follow in the future. Further, the driving trajectory Td preferably represents at least one motion-related physical quantity among, for example, speed, acceleration, jerk, yaw rate, and yaw angle as a motion parameter to be made to appear for each control cycle on such a locus.

The driving control block 140 acquires operation data from the operation determination block 100. The driving control block 140 acquires data of the driving trajectory Td together with the recognition data from the trajectory generation block 120. The driving control block 140 acquires data of past control commands to the host vehicle 2 by reading from the memory 10. Based on these acquired data, the driving control block 140 generates a control command for controlling the driving behavior of the host vehicle 2. At this time, a control command to be sent to the actuator system 4 is generated so as to control a driving task corresponding to an automated driving level adjusted according to the driving scene between the automated driving task and the manual driving assistance task in the host vehicle 2. The control command thus generated is stored in the memory 10.

Examples of the driving task corresponding to the automated driving level include adaptive cruise control (ACC), collision mitigation braking (autonomous emergency braking: AEB), and lane keeping assist (LKA). Thus, the adjustment of the automated driving level preferably includes a handover in which the driving task is transferred between the driving assistance system 1 and the driver by transition of the driving mode between the automated driving task and the manual driving assistance task. Such a handover is realized at at least one timing among, for example, a transfer request timing from the driver, an entry/exit timing for an operational design domain (ODD) of automated driving, and a necessary timing for a minimum risk maneuver (MRM).

### (Driving Assistance Flow)

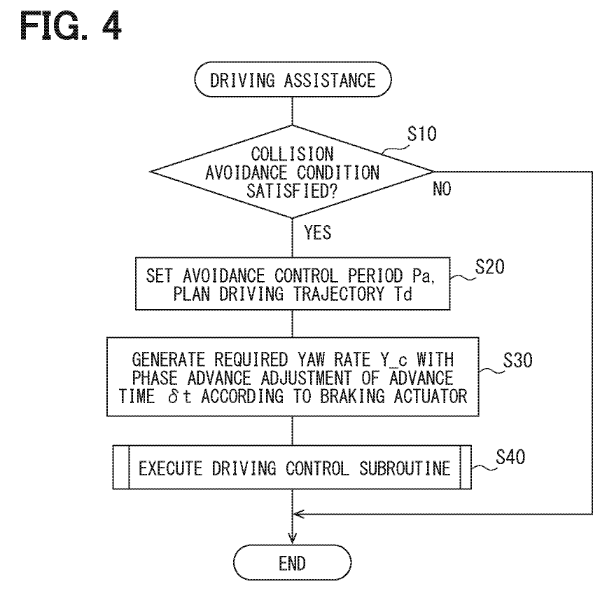

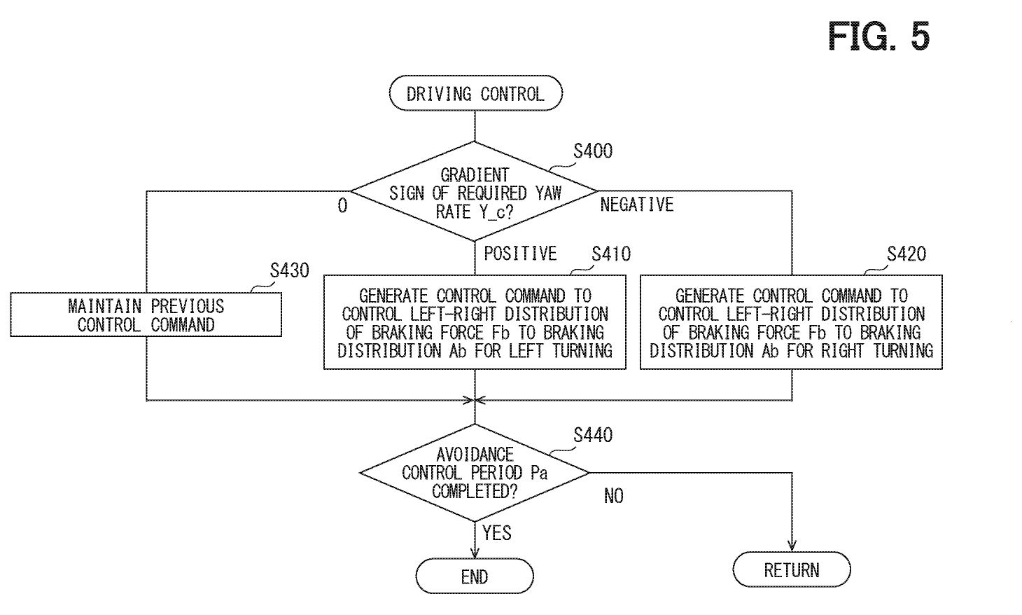

In the first embodiment, a driving assistance flow realizing the driving assistance method for supporting the driving of the host vehicle 2 is repeatedly executed according to FIGS. 4 and 5 by the cooperation of the multiple blocks 100, 120, and 140. In the following description, each "S" in the driving assistance flow means each of multiple steps executed by multiple instructions included in the driving assistance program.

In S10 shown in FIG. 4, the trajectory generation block 120 determines whether or not a collision avoidance condition requiring collision avoidance with the object 3 in the future driving of the host vehicle 2 is satisfied. The collision avoidance condition is satisfied when a collision risk between the host vehicle 2 and the object 3 reaches a collision avoidance range requiring collision avoidance of the host vehicle 2. Thus, the arrival of the collision risk at the collision avoidance range is determined based on the recognition data generated by the trajectory generation block 120. At this time, regarding the collision risk, it may be determined that the collision avoidance range has been reached when the TTC becomes equal to or less than a threshold time (e.g., 2 seconds) or less than the threshold time. In addition to such a TTC requirement, regarding the collision risk, it may be determined that the collision avoidance range has been reached when a necessary probability of collision avoidance by, for example, a lane change becomes equal to or more than a threshold or exceeds the threshold.

In S10, when a negative determination is made due to non-satisfaction of the collision avoidance condition, the current driving assistance flow ends. On the other hand, in S10, when an affirmative determination is made due to satisfaction of the collision avoidance condition, the current driving assistance flow proceeds to S20.

In S20, the trajectory generation block 120 sets an avoidance control period Pa as shown in FIG. 6 in order to execute emergency control of the host vehicle 2 toward collision avoidance. At the same time, in S20, the trajectory generation block 120 plans a driving trajectory Td serving as a tracing target of the host vehicle 2 over the avoidance control period Pa toward collision avoidance with the object 3 in the future driving of the host vehicle 2. At this time, the driving trajectory Td is planned so as to define, as a motion parameter targeted in the future driving of the host vehicle 2, a time-series change of a target yaw rate Y_t as shown in FIG. 6 for each control cycle in addition to the time-series of position coordinates along the planned path/trajectory.

In S30 shown in FIG. 4, the trajectory generation block 120 generates a required yaw rate Y_c required for the host vehicle 2 for each control cycle of the avoidance control period Pa by correcting the target yaw rate Y_t among the motion parameters constituting the driving trajectory Td planned in S20. At this time, as shown in FIG. 6, the phase of the required yaw rate Y_c is adjusted to the advance side by an advance time δt relative to the phase of the target yaw rate Y_t following the planned driving trajectory Td. The sign of the target yaw rate Y_t in FIG. 6 is defined such that the counterclockwise direction is positive and the clockwise direction is negative around the yaw axis in the host vehicle 2 in a top view, but an inverse relationship may of course be defined.

Therefore, the advance time δt, which is the necessary time for such phase advance adjustment in S30, is set according to a response delay time predicted for the actuator system 4. Particularly in the first embodiment, the advance time δt is preferably set according to, for example, a maximum delay time among response delay times occurring when the braking actuator 44 applies each braking force Fb to the front wheels 20fl, 20fr and the rear wheels 20rl, 20rr as shown in FIG. 6 in accordance with the control command from the driving control block 140. The sign of the required yaw rate Y_c in FIG. 6 is defined such that the counterclockwise direction is positive and the clockwise direction is negative around the yaw axis in the host vehicle 2 in a top view, but an inverse relationship may of course be defined. Also, the sign of the braking force Fb in FIG. 6 is defined such that the reverse direction of the host vehicle 2 is negative, but it may of course be defined as a positive sign.

In S40 shown in FIG. 4, the driving control block 140 executes a driving control subroutine so as to generate a control command to the actuator system 4 in accordance with each motion parameter represented by the driving trajectory Td acquired as data from the trajectory generation block 120 after executing S20 and S30. As shown in FIG. 5, in S400 of the driving control subroutine, the driving control block 140 determines a sign of a differential value serving as a gradient (hereinafter referred to as a gradient sign) of the required yaw rate Y_c generated by S30 as a motion parameter constituting the driving trajectory Td.

When it is determined in S400 that the gradient sign of the required yaw rate Y_c is positive, the driving control subroutine proceeds to S410. In S410, the driving control block 140 generates a control command for the braking actuator 44 so as to control the left-right distribution of the braking force Fb applied to each wheel 20 of the host vehicle 2 to a braking distribution Ab correlated with the positive gradient sign and magnitude of the phase-advance-adjusted required yaw rate Y_c as shown in FIG. 6.

Specifically, the control command in S410 is generated so as to cause a left turn correlated with the gradient sign of the required yaw rate Y_c to appear in the host vehicle 2 toward collision avoidance, as exemplified by a period Pal in FIG. 6 among the avoidance control period Pa. The control command in S410 is also generated so as to control each braking force Fb applied to the left front wheel 20fl and rear wheel 20rl, which are on the inner wheel side of the host vehicle 2 turning left toward collision avoidance, to a magnitude correlated with the required yaw rate Y_c. At this time, if the host vehicle 2 is in an override state by the driver through manual driving operation, each braking force Fb to the left front wheel 20fl and rear wheel 20rl may be corrected within a range correlated with the required yaw rate Y_c based on the operation data from the operation determination block 100. Also at this time, each braking force Fb to the left front wheel 20fl and rear wheel 20rl may be differentiated in accordance with the normal load (a ground load) applied from the respective wheels 20fl, 20rl to the road surface.

Further, the control command in S410 is generated so as to determine the left-right braking distribution Ab by controlling each braking force Fb applied to the right front wheel 20fr and rear wheel 20rr, which are on the outer wheel side of the host vehicle 2 turning left, to be substantially zero or a magnitude gradually decreasing according to the left side as exemplified in the period Pal of FIG. 6. That is, the control command at this time controls both the left-right distribution for the front wheels 20fl, 20fr and the left-right distribution for the rear wheels 20rl, 20rr in the host vehicle 2 to the braking distribution Ab for a left turn. Thereby, when the respective braking forces Fb to the left front wheel 20fl and rear wheel 20rl are made different, the left-right distribution for the front wheels 20fl, 20fr and the left-right distribution for the rear wheels 20rl, 20rr are controlled to different braking distributions Ab within a range causing the left turn to appear.

As coordinated control with such braking distribution Ab, the control command in S410 may, in coordination with the braking distribution Ab, increase or decrease at least one of the adjustable common steering angles of the front wheels 20fl, 20fr and the rear wheels 20rl, 20rr in a left-turning direction about the yaw axis of the host vehicle 2. At this time, if the common steering angle of the front wheels 20fl, 20fr and the common steering angle of the rear wheels 20rl, 20rr are independently adjustable, the front-rear distribution between these common steering angles may also be controlled toward the left turn.

When it is determined in S400 shown in FIG. 5 that the gradient sign of the required yaw rate Y_c is negative, the driving control subroutine proceeds to S420. In S420, the driving control block 140 generates a control command for the braking actuator 44 so as to control the left-right distribution of the braking force Fb applied to each wheel 20 of the host vehicle 2 to a braking distribution Ab correlated with the negative gradient sign and magnitude of the phase-advance-adjusted required yaw rate Y_c as shown in FIG. 6.

Specifically, the control command in S420 is generated so as to cause a right turn correlated with the gradient sign of the required yaw rate Y_c to induce in the host vehicle 2 toward collision avoidance, as exemplified by a period Par in FIG. 6 among the avoidance control period Pa. The control command in S420 is also generated so as to control each braking force Fb applied to the right front wheel 20fr and rear wheel 20rr, which are on the inner wheel side of the host vehicle 2 turning right toward collision avoidance, to a magnitude correlated with the required yaw rate Y_c. At this time, if the host vehicle 2 is in an override state by the driver through manual driving operation, each braking force Fb to the right front wheel 20fr and rear wheel 20rr may be corrected within a range correlated with the required yaw rate Y_c based on the operation data from the operation determination block 100. Also at this time, each braking force Fb to the right front wheel 20fr and rear wheel 20rr may be differentiated in accordance with the normal load applied from the respective wheels 20fr, 20rr to the road surface.

Further, the control command in S420 is generated so as to determine the left-right braking distribution Ab by controlling each braking force Fb applied to the left front wheel 20fl and rear wheel 20rl, which are on the outer wheel side of the host vehicle 2 turning right, to be substantially zero or a magnitude gradually decreasing according to the right side as exemplified in the period Par of FIG. 6. That is, the control command at this time controls both the left-right distribution for the front wheels 20fl, 20fr and the left-right distribution for the rear wheels 20rl, 20rr in the host vehicle 2 to the braking distribution Ab for a right turn. Thereby, when the respective braking forces Fb to the right front wheel 20fr and rear wheel 20rr are made different, the left-right distribution for the front wheels 20fl, 20fr and the left-right distribution for the rear wheels 20rl, 20rr are controlled to different braking distributions Ab within a range causing the right turn to appear.

As coordinated control with such braking distribution Ab, the control command in S420 may, in coordination with the braking distribution Ab, increase or decrease at least one of the adjustable common steering angles of the front wheels 20fl, 20fr and the rear wheels 20rl, 20rr in a right-turning direction about the yaw axis of the host vehicle 2. At this time, if the common steering angle of the front wheels 20fl, 20fr and the common steering angle of the rear wheels 20rl, 20rr are independently adjustable, the front–rear allocation (distribution ratio) between the front and rear common steering angles may also be controlled to realize the right turn.

When it is determined in S400 shown in FIG. 5 that the gradient sign of the required yaw rate Y_c is neither positive nor negative, that is, the magnitude of the gradient of the required yaw rate Y_c is substantially zero, the driving control subroutine proceeds to S430. In S430, the driving control block 140 maintains the control command in the previous control cycle in order to correlate the braking distribution Ab with the required yaw rate Y_c toward collision avoidance as exemplified by a period Pa0 in FIG. 6 among the avoidance control period Pa.

After the completion of execution of any of S410, S420, and S430, the driving control subroutine proceeds to S440 as shown in FIG. 5. In S440, the driving control block 140 determines whether or not the avoidance control period Pa in the current driving assistance flow has been completed. As a result, when a negative determination is made during the avoidance control period Pa, the driving control subroutine returns to S400, thereby starting the next control cycle in the current driving assistance flow. On the other hand, when an affirmative determination is made due to the completion of the avoidance control period Pa, the current driving assistance flow including the driving control subroutine ends. As described above, by the driving control subroutine in which S440 is executed for each control cycle from any of S410, S420, and S430, at least the braking force Fb actually applied to the front wheels 20fl, 20fr and the rear wheels 20rl, 20rr is controlled to a timely and appropriate value following the target yaw rate Y_t in the avoidance control period Pa as shown in FIG. 6.

### (Effects)

The effects of the first embodiment described above will be described below.

According to the first embodiment, the phase of the required yaw rate Y_c required for the host vehicle 2 is adjusted to be phase-advanced relative to the phase specified by the driving trajectory Td planned for the host vehicle 2 to avoid a collision. Thus, the left-right distribution of the braking force Fb applied from the braking actuator 44 to the wheels 20 in the host vehicle 2 is controlled to the braking distribution Ab correlated with the phase-advance-adjusted required yaw rate Y_c. According to this, even if a response delay of the braking force Fb occurs in the braking actuator 44, the response delay itself can be canceled by starting the control of the braking distribution Ab following the advanced phase of the required yaw rate Y_c. Therefore, the braking force Fb following the driving trajectory Td can be distributed to the left and right wheels 20 in a timely manner to cause the host vehicle 2 to accurately trace the driving trajectory Td, thereby making it possible to realize driving assistance effective for collision avoidance with the object 3 in the host vehicle 2.

In the distribution control of the braking force Fb according to the first embodiment, both the left-right distribution for the front wheels 20fl, 20fr and the left-right distribution for the rear wheels 20rl, 20rr in the host vehicle 2 are controlled to the braking distribution Ab. According to this, in parallel with distributing the braking force Fb following the driving trajectory Td to the left and right front wheels 20fl, 20fr in a timely manner, the braking force Fb following the driving trajectory Td is also distributed to the left and right rear wheels 20rl, 20rr in a timely manner, allowing the host vehicle 2 to trace the driving trajectory Td precisely. Therefore, effective driving assistance capable of ensuring reliability in collision avoidance with the object 3 in the host vehicle 2 becomes possible.

In the distribution control of the braking force Fb according to the first embodiment, the left-right distribution for the front wheels 20fl, 20fr and the left-right distribution for the rear wheels 20rl, 20rr in the host vehicle 2 may be controlled to different braking distributions Ab. In this case, in parallel with timely distributing the braking force Fb following the driving trajectory Td to an appropriate value for the left and right front wheels 20fl, 20fr, the braking force Fb following the driving trajectory Td can be timely distributed to an appropriate value for the left and right rear wheels 20rl, 20rr, allowing the host vehicle 2 to trace the driving trajectory Td with high accuracy. Therefore, effective driving assistance capable of ensuring high reliability in collision avoidance with the object 3 in the host vehicle 2 becomes possible.

The distribution control of the braking force Fb according to the first embodiment may be performed in an override state of the driver for the host vehicle 2. In this case, with respect to the driver's override, the braking force Fb following the driving trajectory Td is distributed to the left and right wheels 20 in a timely manner, thereby realizing the intended behavior on the driving trajectory Td in the host vehicle 2. Therefore, effective driving assistance for collision avoidance with the object 3 can be realized even in the host vehicle 2 where a manual driving operation by the driver is assumed.

### (Second Embodiment)

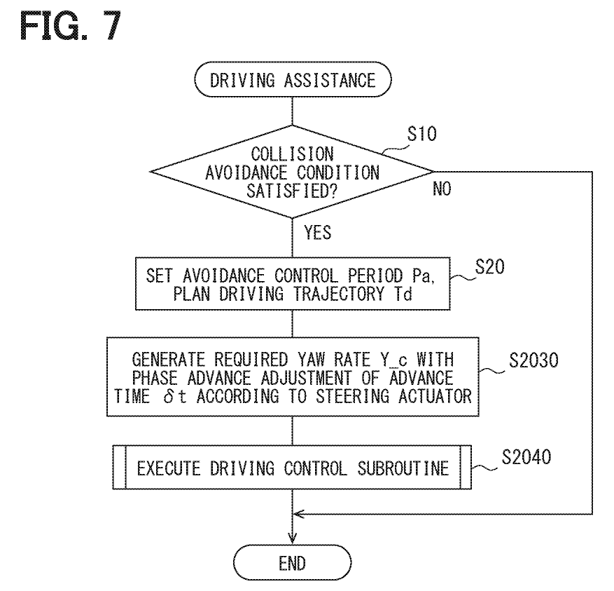

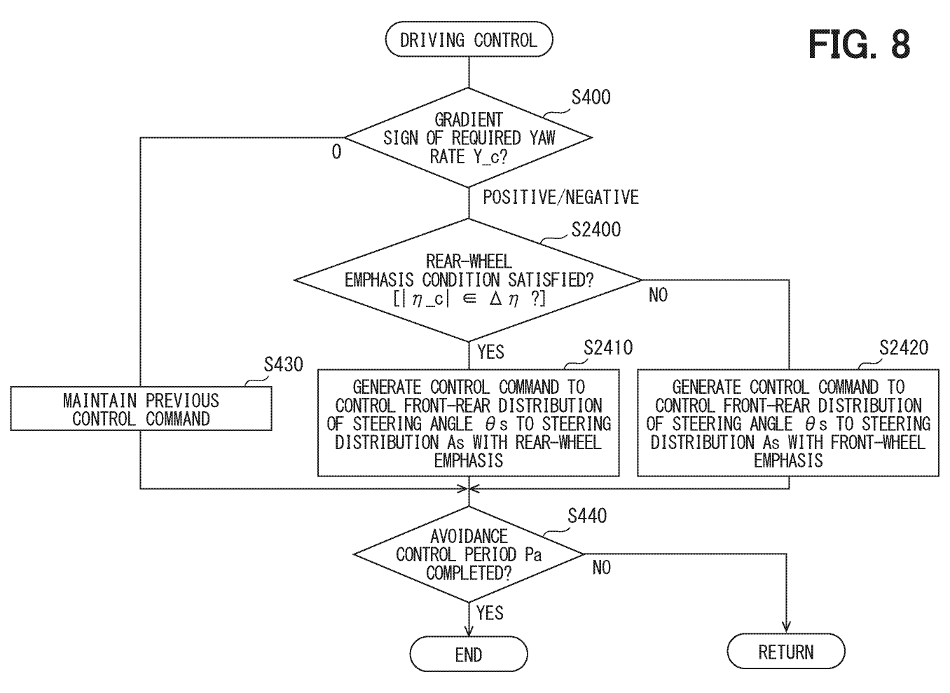

A second embodiment is a modification of the first embodiment. As shown in FIG. 7, in a driving assistance flow of the second embodiment, S2030 and S2040 are executed instead of S30 and S40. Therefore, as shown in FIG. 8, a driving control subroutine in S2040 of the second embodiment executes S2400, S2410, and S2420 replacing S410 and S420 of the first embodiment, between S400 and S430 which correspond to the first embodiment. In the second embodiment realizing the driving assistance flow including such a driving control subroutine, the steering actuator 42 adjusts both the common steering angle of the front wheels 20fl, 20fr and the common steering angle of the rear wheels 20rl, 20rr. Accordingly, in the second embodiment, the front-rear distribution of the common steering angles between the front wheels 20fl, 20fr and the rear wheels 20rl, 20rr is controllable.

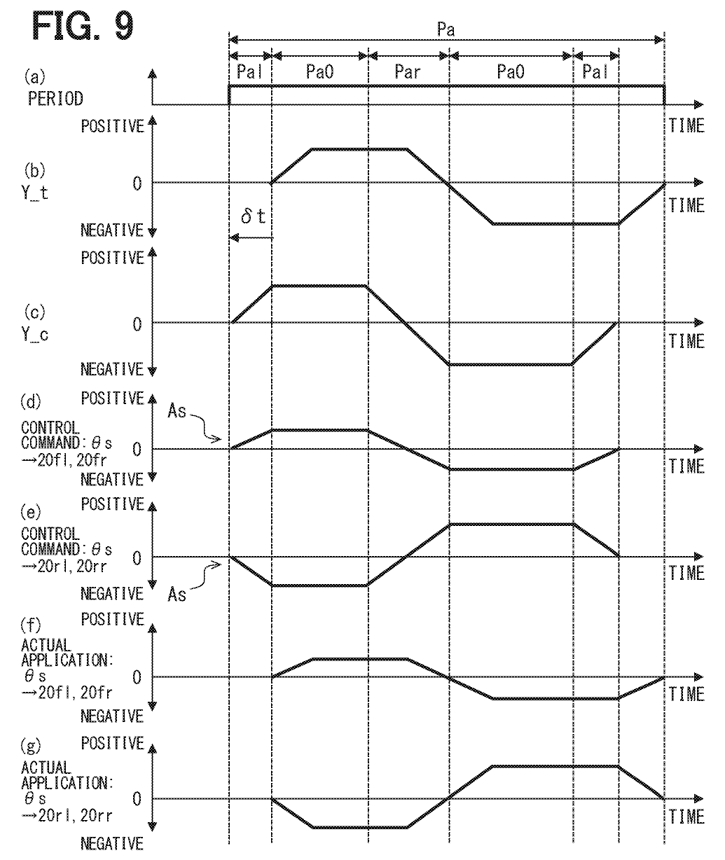

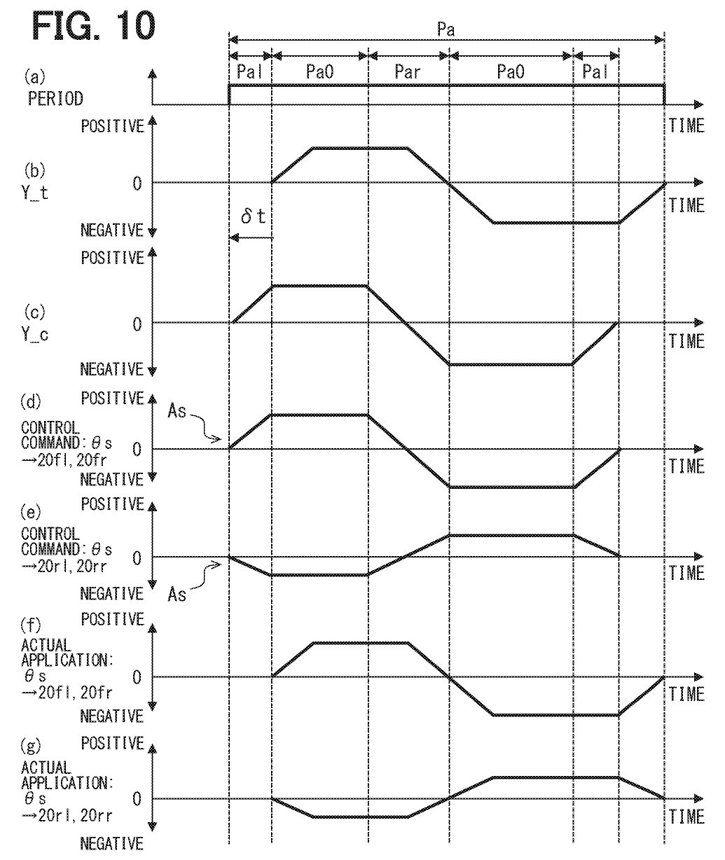

In detail, in S2030 in the driving assistance flow of the second embodiment as in FIG. 7, the setting of the advance time δt, which serves as a phase-advance adjustment amount for the required yaw rate Y_c, is different from S30 of the first embodiment. That is, in S2030, the advance time δt is preferably set according to, for example, a maximum delay time among response delay times occurring when the steering actuator 42 applies a common steering angle θs of the front wheels 20fl, 20fr and a common steering angle θs of the rear wheels 20rl, 20rr as shown in FIGS. 9 and 10 in accordance with the control command from the driving control block 140.

Further, the driving control subroutine in the driving assistance flow of the second embodiment as in FIG. 8 proceeds to S2400 when it is determined in S400 that the gradient sign of the required yaw rate Y_c is either positive or negative. In S2400, the driving control block 140 determines whether or not a rear-wheel emphasis condition that places importance on steering of the rear wheels 20rl, 20rr rather than the front wheels 20fl, 20fr is satisfied in the host vehicle 2. The rear-wheel emphasis condition is satisfied when the absolute value of the differential value serving as the gradient of the required yaw rate Y_c, that is, the magnitude (|η_c|) of a yaw angular acceleration η_c equivalent to the gradient, reaches a rear-wheel emphasis range Δη where importance is placed on steering of the rear wheels 20rl, 20rr rather than the front wheels 20fl, 20fr.

In S2400 shown in FIG. 8, when it is determined that the rear-wheel emphasis condition is satisfied, that is, the magnitude of the yaw angular acceleration η_c has risen to the rear-wheel emphasis range Δη, the driving control subroutine proceeds to S2410. In S2410, the driving control block 140 generates a control command for the steering actuator 42 so as to control the front-rear distribution of the steering angle θs applied to each wheel 20 of the host vehicle 2 to a steering distribution As correlated with the sign (i.e., equivalent to the gradient sign of the first embodiment) and magnitude of the yaw angular acceleration η_c which is the gradient of the phase-advance-adjusted required yaw rate Y_c as shown in FIG. 9.

Specifically, the control command in S2410 is generated so as to cause a left turn or a right turn correlated with the sign of the yaw angular acceleration η_c to appear in the host vehicle 2 toward collision avoidance, as exemplified by periods Pal and Par in FIG. 9 among the avoidance control period Pa. The sign of the steering angle θs in FIG. 9 and FIG. 10 described later is defined such that the counterclockwise direction is positive and the clockwise direction is negative around the yaw axis from the front-rear axis in the host vehicle 2 in a top view according to the required yaw rate Y_c described in the first embodiment, but an inverse relationship may of course be defined.

Further, the control command in S2410 is generated so as to control the steering distribution As to a rear-wheel emphasized front-rear distribution in which the common steering angle θs of the rear wheels 20rl, 20rr is adjusted to be larger than the common steering angle θs of the front wheels 20fl, 20fr. At this time, the steering distribution As is preferably set such that a relative ratio for increasing the steering angle θs of the rear wheels 20rl, 20rr with respect to the front wheels 20fl, 20fr has a correlation following, for example, proportionally to, the magnitude of the yaw angular acceleration η_c. Thus, the common steering angle θs of the front wheels 20fl, 20fr and the common steering angle θs of the rear wheels 20rl, 20rr are controlled to magnitudes correlated with the required yaw rate Y_c within a range satisfying such steering distribution As. Also at this time, if the host vehicle 2 is in an override state by the driver through manual driving operation, the front-rear steering distribution As may be corrected within a range satisfying the correlation with the motion parameters η_c, Y_c based on the operation data from the operation determination block 100. Further at this time, if a difference in response delay time occurs between the common steering angle θs of the front wheels 20fl, 20fr and the common steering angle θs of the rear wheels 20rl, 20rr, the start timing of the control command may be made different according to the difference.

As coordinated control with such steering distribution As, the control command in S2410 may be generated so as to control (increase or decrease) the left-right braking distribution Ab for each of the front wheels 20fl, 20fr and for each of the rear wheels 20rl, 20rr. At this time, the braking distribution Ab commanded by the control command may be determined by, for example, conforming to one step among S410 and S420 of the first embodiment matched with the gradient sign of the required yaw rate Y_c equivalent to the sign of the yaw angular acceleration η_c.

On the other hand, when it is determined in S2400 shown in FIG. 8 that the rear-wheel emphasis condition is not satisfied, that is, the magnitude of the yaw angular acceleration η_c has not reached the rear-wheel emphasis range Δη, the driving control subroutine proceeds to S2420. In other words, when it is determined that a front-wheel emphasis condition is satisfied because the magnitude of the yaw angular acceleration η_c falls within a front-wheel emphasis range where importance is placed on steering of the front wheels 20fl, 20fr rather than the rear wheels 20rl, 20rr, the driving control subroutine proceeds to S2420. In S2420, the driving control block 140 generates a control command for the steering actuator 42 so as to control the front-rear distribution of the steering angle θs applied to the wheels 20 of the host vehicle 2 in accordance with a steering distribution As correlated with the sign and magnitude of the yaw angular acceleration η_c as shown in FIG. 10. Specifically, the control command in S2420 is generated so as to cause the host vehicle 2 to execute a left turn or a right turn correlated with the sign of the yaw angular acceleration η_c to avoid collision, as exemplified by periods Pal and Par in FIG. 10 among the avoidance control period Pa.

Further, the control command in S2420 is generated so as to control the steering distribution As to a front-wheel emphasized front-rear distribution in which the common steering angle θs of the front wheels 20fl, 20fr is adjusted to be larger than the common steering angle θs of the rear wheels 20rl, 20rr. At this time, the steering distribution As is preferably set such that a relative ratio for increasing the steering angle θs of the front wheels 20fl, 20fr with respect to the rear wheels 20rl, 20rr has a correlation inversely following, for example, inversely proportionally to, the magnitude of the yaw angular acceleration η_c. Thus, the common steering angle θs of the front wheels 20fl, 20fr and the common steering angle θs of the rear wheels 20rl, 20rr are controlled to magnitudes correlated with the required yaw rate Y_c within a range satisfying such steering distribution As. Also at this time, if the host vehicle 2 is in an override state by the driver through manual driving operation, the front-rear steering distribution As may be corrected within a range satisfying the correlation with the motion parameters η_c, Y_c based on the operation data from the operation determination block 100. Further at this time, if a difference in response delay time occurs between the common steering angle θs of the front wheels 20fl, 20fr and the common steering angle θs of the rear wheels 20rl, 20rr, the start timing of the control command may be made different according to the difference.

As coordinated control with such steering distribution As, the control command in S2420 may be generated so as to also control (increase or decrease) the left-right braking distribution Ab for the front wheels 20fl, 20fr and for the rear wheels 20rl, 20rr, respectively. Also at this time, the braking distribution Ab commanded by the control command may be determined by, for example, conforming to one step among S410 and S420 of the first embodiment matched with the sign of the yaw angular acceleration η_c.

From the above, in the driving control subroutine of the second embodiment, S440 is executed in each control cycle after the subroutine proceeds from any of S2410, S2420, and S430. As a result, in the avoidance control period Pa of the second embodiment as shown in FIGS. 9 and 10, at least the steering angles θs actually applied to the front wheels 20fl, 20fr and the rear wheels 20rl, 20rr is controlled to a timely and appropriate value following the target yaw rate Y_t.

### (Effects)

The effects of the second embodiment described above will be described below.

According to the second embodiment, the phase of the required yaw rate Y_c required for the host vehicle 2 is adjusted to be advanced relative to the phase following the driving trajectory Td planned for the host vehicle 2 toward collision avoidance. Thus, the front-rear distribution of the steering angle θs applied from the steering actuator 42 to the wheels 20 in the host vehicle 2 is controlled to the steering distribution As correlated with the phase-advance-adjusted required yaw rate Y_c. With this configuration, even if a response delay of the steering angle θs occurs in the steering actuator 42, the response delay itself can be canceled by starting the control of the steering distribution As following the advanced phase of the required yaw rate Y_c. Therefore, the steering angle θs following the driving trajectory Td can be distributed to the front and rear wheels 20 in a timely manner to cause the host vehicle 2 to accurately trace the driving trajectory Td, thereby making it possible to realize driving assistance effective for collision avoidance with the object 3 in the host vehicle 2.

The distribution control of the steering angle θs according to the second embodiment may be performed in an override state of the driver for the host vehicle 2. In this case, even during the driver’s override, the steering angle θs following the driving trajectory Td is distributed to the front and rear wheels 20 in a timely manner, thereby allowing the host vehicle 2 to realize the intended behavior on the driving trajectory Td. Therefore, effective driving assistance for collision avoidance with the object 3 can be realized even in the host vehicle 2 where a manual driving operation by the driver is assumed.

### (Other Embodiments)

Multiple embodiments have been described above, but the present disclosure should not be construed as being limited to these embodiments, and can be applied to various embodiments and combinations without departing from the gist of the present disclosure.

In a modification, the dedicated computer constituting the driving assistance system 1 may have at least one of a digital circuit and an analog circuit as a processor. Here, the digital circuit is at least one type among, for example, an ASIC (Application Specific Integrated Circuit), an FPGA (Field Programmable Gate Array), an SoC (System on a Chip), a PGA (Programmable Gate Array), and a CPLD (Complex Programmable Logic Device). Such a digital circuit may have a memory storing a program.

In a modification, the operator manually operating the host vehicle 2 to which the driving assistance system 1 is applied may be a remote operator who remotely operates the driving of the host vehicle 2 from an external center. In a modification, the driving assistance system 1 may be configured to be realizable only for the automated driving task without the manual driving assistance task supporting the manual driving operation of the operator.

In a modification, the rear-wheel emphasis condition may be set to a condition satisfied in response to the driver holding the steering wheel of the host vehicle 2 in, for example, an override state. In a modification, the rear-wheel emphasis condition may be set to a condition satisfied in response to the actual yaw rate of the host vehicle 2 rising to a rear-wheel emphasis range in which the actual yaw rate exceeds a predetermined threshold. In a modification, the rear-wheel emphasis condition may be set to a condition satisfied in response to a lateral movement amount of the host vehicle 2 in the avoidance control period Pa falling within a rear-wheel emphasis range in which the lateral movement amount is less than a predetermined threshold. Among the rear-wheel emphasis conditions of these modifications, at least one condition may be determined during execution of S2400 in addition to or instead of the rear-wheel emphasis condition described in the second embodiment regarding the magnitude of the yaw angular acceleration η_c.

What is claimed is:

1. A driving assistance system for assisting collision avoidance with an object during driving of a host vehicle, the driving assistance system comprising:
a processor configured to execute:
performing phase advance adjustment of a phase of a required yaw rate required for the host vehicle so as to be advanced relative to a phase that follows a driving trajectory planned for the host vehicle toward collision avoidance; and
controlling, in the host vehicle, a left-right distribution of braking force applied from a braking actuator to wheels to a braking distribution correlated with the required yaw rate subjected to the phase advance adjustment as a distribution control of the braking force.

2. The driving assistance system according to claim 1, wherein
the distribution control of the braking force includes controlling both the left-right distribution for a front wheel and the left-right distribution for a rear wheel in the host vehicle to the braking distribution.

3. The driving assistance system according to claim 2, wherein
the distribution control of the braking force includes controlling the left-right distribution for the front wheel and the left-right distribution for the rear wheel to different braking distributions.

4. The driving assistance system according to claim 1, wherein
the distribution control of the braking force is performed during a driver override state with respect to the host vehicle.

5. The driving assistance system according to claim 1, wherein
the processor is further configured to execute controlling a front-rear distribution of a steering angle applied from a steering actuator to the wheels in the host vehicle to a steering distribution correlated with the required yaw rate subjected to the phase advance adjustment.

6. A driving assistance system for assisting collision avoidance with an object during driving of a host vehicle, the driving assistance system comprising:
a processor configured to execute:
performing phase advance adjustment of a phase of a required yaw rate required for the host vehicle so as to be advanced relative to a phase that follows a driving trajectory planned for the host vehicle toward collision avoidance; and
controlling, in the host vehicle, a front-rear distribution of a steering angle applied from a steering actuator to wheels to a steering distribution correlated with the required yaw rate subjected to the phase advance adjustment.

7. The driving assistance system according to claim 6, wherein
the distribution control of the steering angle includes, when a rear-wheel emphasis condition is satisfied in the host vehicle that places emphasis on steering of a rear wheel over a front wheel, controlling the front-rear distribution to the steering distribution that adjusts the steering angle to be larger at the rear wheel than at the front wheel.

8. The driving assistance system according to claim 7, wherein
the distribution control of the steering angle includes controlling, when the rear-wheel emphasis condition is satisfied as a result of a magnitude of a yaw angular acceleration, which is a gradient of the required yaw rate, increasing up to a rear-wheel emphasis range in which steering of the rear wheel is emphasized over steering of the front wheel in the host vehicle, the front-rear distribution to be the steering distribution that adjusts the steering angle to be larger at the rear wheel than at the front wheel.

9. The driving assistance system according to claim 6, wherein
the distribution control of the steering angle is performed during a driver override state with respect to the host vehicle.

10. A non-transitory computer readable storage medium storing a driving assistance program for assisting collision avoidance with an object in driving of a host vehicle, the driving assistance program including instructions for causing a processor to execute the assistance, the instructions causing the processor to execute:
performing phase advance adjustment of a phase of a required yaw rate required for the host vehicle so as to be advanced relative to a phase that follows a driving trajectory planned for the host vehicle toward collision avoidance; and
controlling, in the host vehicle, a left-right distribution of a braking force applied from a braking actuator to wheels to a braking distribution correlated with the required yaw rate subjected to the phase advance adjustment.

11. A non-transitory computer readable storage medium storing a driving assistance program for assisting collision avoidance with an object in driving of a host vehicle, the driving assistance program including instructions for causing a processor to execute the assistance, the instructions causing the processor to execute:
performing phase advance adjustment of a phase of a required yaw rate required for the host vehicle so as to be advanced relative to a phase that follows a driving trajectory planned for the host vehicle toward collision avoidance; and
controlling, in the host vehicle, a front-rear distribution of a steering angle applied from a steering actuator to wheels to a steering distribution correlated with the required yaw rate subjected to the phase advance adjustment.

12. A driving assistance method executed by a processor for assisting collision avoidance with an object in driving of a host vehicle, the driving assistance method comprising:
performing phase advance adjustment of a phase of a required yaw rate required for the host vehicle so as to be advanced relative to a phase that follows a driving trajectory planned for the host vehicle toward collision avoidance; and
controlling, in the host vehicle, a left-right distribution of a braking force applied from a braking actuator to wheels to a braking distribution correlated with the required yaw rate subjected to the phase advance adjustment.

13. A driving assistance method executed by a processor for assisting collision avoidance with an object in driving of a host vehicle, the driving assistance method comprising:
performing phase advance adjustment of a phase of a required yaw rate required for the host vehicle so as to be advanced relative to a phase that follows a driving trajectory planned for the host vehicle toward collision avoidance; and
controlling, in the host vehicle, a front-rear distribution of a steering angle applied from a steering actuator to wheels to a steering distribution correlated with the required yaw rate subjected to the phase advance adjustment.
